(19) United States
(12) Patent Application Publication
(10) Pub. No.: US 2010/0057533 A1
(43) Pub. Date: Mar. 4, 2010

(54) MULTIDIMENSIONAL METHOD AND COMPUTER SYSTEM FOR PATENT AND TECHNOLOGY PORTFOLIO RATING AND RELATED DATABASE

(75) Inventors: Alba Martinez Ruiz, Concepcion (CL); Tomas Aluja Banet, Barcelona (ES)

Correspondence Address: RATNERPRESTIA, P.O. BOX 980, VALLEY FORGE, PA, 19482, US

(73) Assignees: Universidad Catolica de la SSMA, Concepcion, Concepcion (CL); Universidad Politecnica de Catalunya, Barcelona (ES)

(21) Appl. No.: 12/205,136

(22) Filed: Sep. 5, 2008

(30) Foreign Application Priority Data
Sep. 4, 2008 (ES) P200802549

(51) Int. Cl. G06Q 10/00; G06Q 50/00

(52) U.S. Cl. 705/10

(57) ABSTRACT

A predetermined number of manifest or measurable variables is extracted from each of a plurality of patent documents obtained from a data base or another source and from these manifest variables four or more first order latent variables are defined comprising: knowledge stock, technological scope, international scope and patent value for each patent document and a dependency or causality relationship between the manifest and latent variables and between latent variables is defined. In order to rank the patent documents a PLS Path model operable on the manifest variables is constructed taking into account the latent variables and defined relationships among them, and by applying said PLS Path model the value of the latent variables and the dependency relationship between manifest and latent variables and between latent variables is estimated and the value of the latent variables estimated is used to rank the patent documents.

### FIELD OF THE INVENTION

The present invention relates to the field of econometric models and data analysis tools and provides a computer implemented method including a new multidimensional and structural model conceived for technology/patent valuation based on patent portfolio of companies which may in addition also be set to consider company market value among others.

The invention also refers to a computer system to implement the method as well as to at least a related database with economical data to feed the method.

The objective of this invention is not obtaining a monetary value of a patent, but rather relate the different dimensions that affect their value to obtain, among others, a patent value index that allow to sort the patent portfolio from highest to lowest value. These tools allow the company to improve strategy of developing new products/inventions, the intellectual property policy and the technology comparison with the competitors, among others.

### BACKGROUND OF THE INVENTION

Patents constitute one of the more important technological information sources, which allow the study of innovation and trends of technical change.

Up to now research in this field has been mainly associated to the analysis of:
a) information contained in the document of a patent through its indicators, and
b) the relation between patents and R&D, innovation or economic growth.

The amount of patents of a country or in a technological area, or the evolution of the number of patents through the years, corresponds to indicators that have been used by governments, universities, companies or research centers to establish the present situation and the tendencies of a certain technological field, to measure their technology capacity and compare with competitors and also an indicator of the success of the efforts of investigation and development. In recent years patent indications have been used to study the economical value of the patent. Some of them have focused on the relation between market value, research and development and number of patents or number of citations (B. H. Hall and A. Jaffe and M. Trajtenberg “Market Value and Patent Citations” Rand Journal of Economics, Vol. 36 N^{o} 1, Spring 2005), the relation between citations-weighted patent count and social value of innovations, the patents as individual intellectual assets (D. Harhoff and F. M. Scherer and K. Vopel “Citations, Family Size, Opposition and the Value of Patent Rights” Research Policy 32 (2003) 1343-1363), patent indicators and patent value (see M. Reitzig “What Determines Patent Value?. Insights from the Semiconductor Industry”, Research Policy 2003, 32 (1):13-26) and the relationship between patent value and patenting strategy, technological diversity, domestic and international collaborations).

However, up to now the analysis approach has been based on statistical modeling techniques such as case analysis, survey analysis and standard econometric regression analysis (probit or logit models).

U.S. Pat. No. 6,556,992 concerns a computer automated method for rating or ranking patents or other intangible assets comprising selecting two populations of patents each having particular quality or characteristics, providing a computer accessible database of selected patent metrics representative of characteristics of each said patents in said first and second patent populations and constructing a computer regression model based on said selected patent metrics operable to input said selected patent metrics for each said patent and using said regression model to rate or rank one or more patents in a third patent population.

US 2004/0220842 discloses a method for estimating the probability of a future event occurring relative to a particular identified intellectual property asset or group of intellectual property assets of interest, comprising the construction of a predictive computer model or algorithm based on a stored series of data and to perform certain mathematical or statistical calculations thereon to generate an output score wherein operating said computer model leads to calculate a relative ranking or estimated probability of the event occurring in the future relative to said identified intellectual property asset or group of intellectual property assets of interest.

Other approaches to ranking patents using classification tools of variables appear disclosed in U.S. Pat. No. 7,188,069, US 2005/0010515 and US 2008/0091620.

This invention proposes a multidimensional and structural approach that established relationship among manifest and latent variables obtained from the inputted data extracted from the patent documents that differs from cited approaches in that it considers all the involved variables together and the relationship among said variables in a formative way and in a reflective way.

Another contribution of present invention is associated to the fact that the value of technology is approximated from treatment of patent information data and the conditions of the applicants or owners in general companies are obtained from data about market value that in this invention is combined with the other data.

A reason that could explain why a multidimensional and structural approach has not been applied yet to technology/patent valuation is that more generally structural models are based on maximum likelihood estimation and normal distribution of data. Patent indicators are very heterogeneous and asymmetric, and in general they exhibit large variances and skewness. As a consequence to assume that this kind of data has a normal distribution may lead to bias results.

### BRIEF SUMMARY OF THE INVENTION

The present invention solves the problems of the prior art by using partial least square path modeling (PLSPM). PLSPM is an iterative algorithm that offers an explicit estimation of the latent variables. From data analysis standpoint, it is prediction-oriented and a flexible approach to multi-block analysis. Moreover, the invention considers some dimensions/unobserved variables that have not previously been studied together, as the knowledge stock required by the firm to generate an invention, its technological and international scope, the usefulness of the technology, the technological influence on the market value of the firm and the value of technology itself.

According to the invention the proposed method for patent and technology portfolio rating, implemented in a computer comprises according to a first or basic embodiment the following steps:
selecting a large group of patent documents from a database or other source;
extracting a predetermined number of manifest or measurable variables (indicators) from each of the patent documents such as backward citations, number of inventors, number of applicants, number of IPC and number of claims;
defining for each patent document taking into consideration a selected number of said manifest variables in a first preferred approach the following four underlying first order latent variables:
   knowledge stock,
   technological scope,
   international scope, and
   patent value
      and defining a dependency or causality relationship between said manifest and latent variables and between latent variables;
constructing a PLS Path model operable on said manifest variables taking into account said latent variables and defined relationships among them and obtaining the value of said latent variables and the dependency relationship between manifest and latent variables and between latent variables; and
using said obtained values of the latent variables to construct a rank of the selected patent documents.

In addition, the significance level of the obtained values of said manifest and latent variables is obtained in order to obtain the significance of each dependency or causality relationship between said manifest and latent variables and between latent variables.

While the method can be applied to any number of patent documents of relative size from example of around 30 members, the effects of the method become more robust in document groups of at least 100 documents. In any case the method does not need to have a sample with large patent portfolios by a company.

The extraction comprises collection of indicators from the patent documents and well known ordinary mathematic transformation on said data in order to provide a homogeneous sample.

### BRIEF DESCRIPTION OF THE DRAWINGS

FIGS. 1 to 4 illustrate the manifest and latent variable and their relationship used as a basis to implement the method according with the invention.

FIG. 5 is a graphic depicting the relation between latent and manifest variables in a formative way.

FIG. 6 is another graphic illustrating the relation between latent and manifest variables in a reflective way.

### DETAILED DESCRIPTION OF THE INVENTION

The computer-implemented method of this invention considers in general the construction of six underlying latent variables or indexes:
knowledge stock,
technological scope
international scope
patent value
technological usefulness, and
market value

Each of said basic latent variables is following in detail explained:

Knowledge stock represents the base of knowledge (existing previously) used by an applicant or owner and is evaluated from at least the following patent indicators: backwards citations and the number of inventors (formative relation). Other indicators as the number of applicants can also be used. An index of knowledge base by applicant or owner can be estimated as the sum of knowledge units used in the inventions for the applicant or owner.

Technological scope is related with applying an invention in different technological fields and is evaluated or assessed from at least the number of claims and the number of technological classification where the patent is protected (formative relation).

Said two last manifest variables are related with the degree of patent protection of the patent and with the possibility that the technology meets a wide range of needs in the future (J. Lerner “The Importance of Patent Scope: An Empirical Analysis”, Rand Journal of Economics Vol. 25 N^{o}2, 1994, X. S. Tong and J. D. Frame “Measuring National Technological Performance with Patent Claims Data” Research Policy, 1994, 23(2):133-141).

International scope refers to the geographic zones where the invention is protected after application and is estimated from dummy variables (that can adopt the values 1 or 0 value to describe occurrence or not of the variable), to consider whether the invention has been protected in the major market related with the technical fields of the invention (formative relation) during the priority period or international phase period (PCT patents).

Patent value is related with the importance that a patent has for the future technological developments and the subsequent value of technology and when is a first order variable is evaluated using as indicator at least the number of occasions that the patent is cited (reflective relation). The number of countries where the patent is protected or the size of patent family, the number of oppositions or the number of times that the patent is renewed can be also used as indicators.

Technological usefulness of an applicant or owner of a patent is evaluated using as indicator at least the forward citations (reflective relation), when the patent value is a second-order latent variable. The size of patent family, the number of oppositions or the number of times that a patent is renewed can also be used as indicators (see A. Martinez-Ruiz and T. Aluja Second-order Model of Patent and Market Value” International Conference on Computational Statistics COMPSTAT 2008, August 24-29, Porto).

Market value of an applicant or owner of a patent document is defined from manifest variables from economical indicators as the total asset and R&D expenditures of the applicant or owner (formative relation).

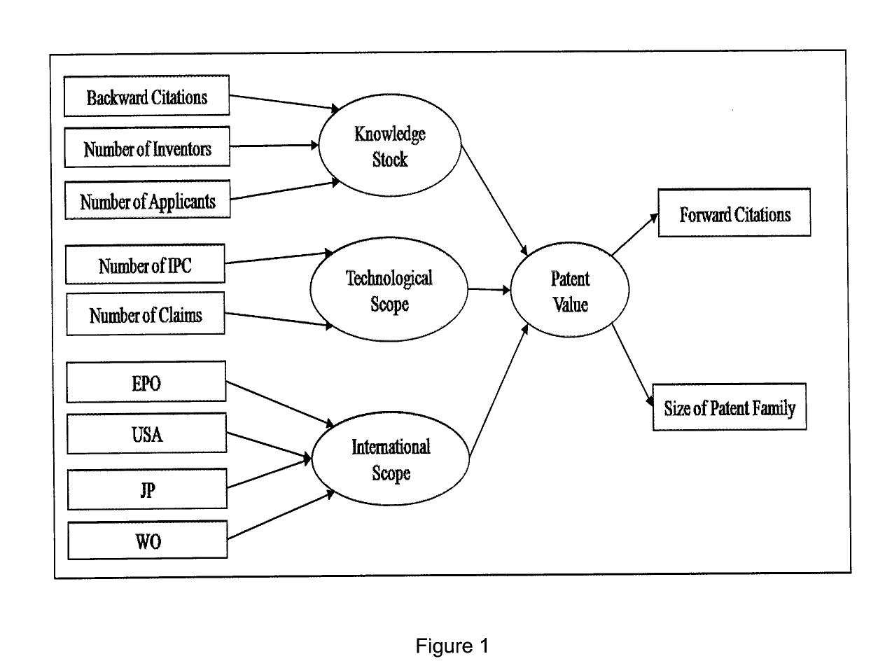

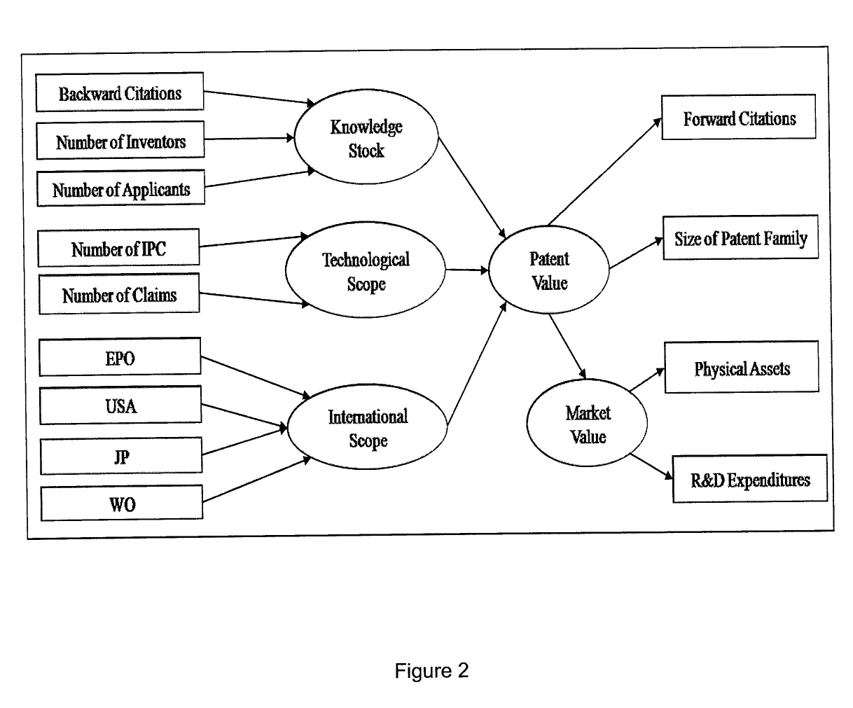

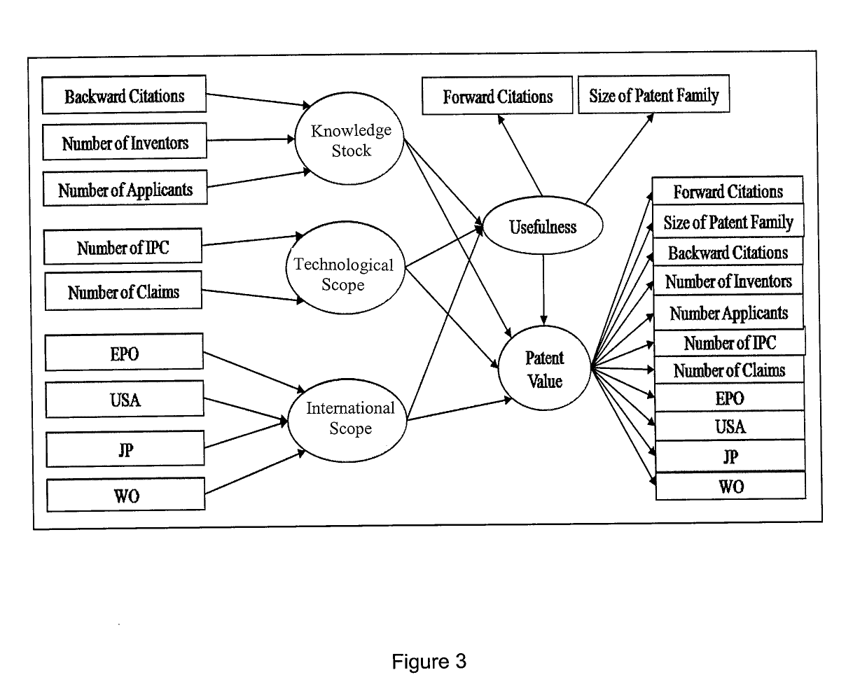

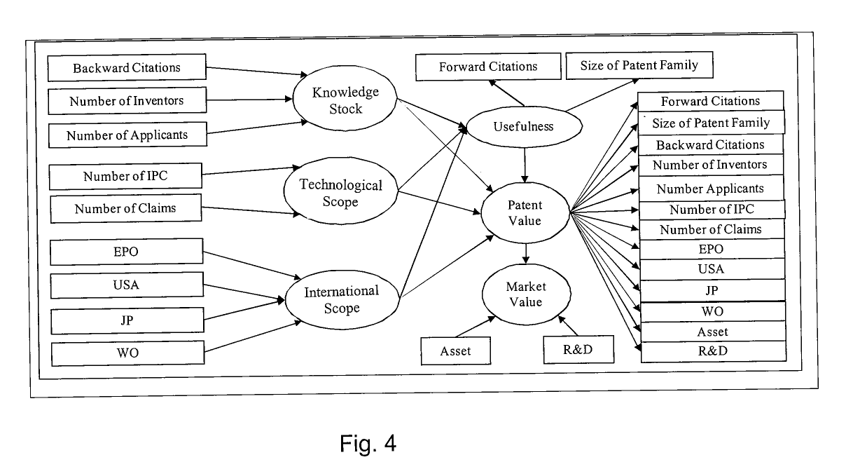

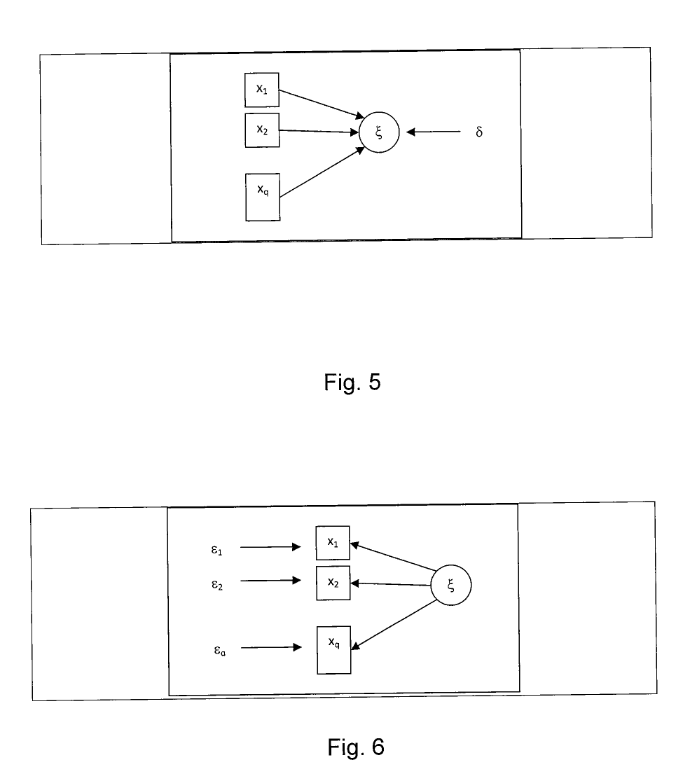

According to the method proposed said variables are used together in four different ways (multidimensional approach) as per the following detail:
(Model A) Patent value is a first-order latent variable. Knowledge stock, technological scope and international scope have a formative relation with patent value and the latter has a reflective relation with the market value (FIG. 2)
(Model B) Is the same as model A but without reflective relation with the market value (FIG. 1)
(Model C) Patent value is a second-order latent variable. Knowledge stock, technological scope, international scope and technological usefulness have a formative relation with patent value and the latter has a reflective relation with the market value. Moreover, in this last case, knowledge stock, technological scope and international scope have also a formative relation with the technological usefulness of the invention (FIG. 4)
(Model D) Is the same as Model C but without considering reflective relation with the market value (FIG. 3)

In the implementation of the invention three methods are applied: Partial Least Square Path Modeling and bootstrapping, multiple imputation techniques and hierarchical component models.

Partial least Square is used to estimate the models (see H. Wold, “Model Construction and Evaluation When Theoretical Knowledge Is Scarce—Theory and Application of Partial Least Square” in Evaluation of Econometrics Models, J. Kmenta and J. G. Ramsey, eds. New York, Academic Press, 1980, 47-74).

Each latent variable is estimated as a weighted aggregate of its indicators (outer model). The weights of the indicators in each aggregate are determined by the weights relations of the various blocks of variables. Simple regressions relate reflective block of variables with latent variables: xⱼₕ=πⱼₕ₀+πⱼₕξⱼ+εⱼₕ where πᵢⱼ are denominated loadings and Xjh are the indicators that describe the latent variable ξⱼ. In this case, indicators are measurements that reveal the effect of the construct. Linear function plus a residual relate formative blocks of variables with latent variables: ξᵢ=Σₕwⱼₕxⱼₕ+δⱼ, where wⱼₕ are denominated weights. In this case the indicators form or cause the change in each latent variable. Ordinary multiple regressions can be used among other to relate latent variables: ξⱼ=βⱼ₀+Σᵢβⱼᵢξᵢ+vⱼ, where βⱼᵢ are the parameters that measure the relationship between constructs and are called path coefficients (inner model).

The estimation proceeds in three stages: (1) an iterative procedure estimates the weights and the latent variables, (2) the latent variables estimated in the first stage provide regressors for estimating the other unknown coefficients of the model by OLS regressions among others, and (3) the location parameter are estimated.

Loadings indicate how the indicators reflect its latent variable in reflective blocks of variables. A low value of loading factor means that the indicator has little relation with the associated construct. To assess the internal consistency or unidimensionality of reflective blocks of variables, it makes use of Cronbach's alpha coefficient (should be >0.7), principal component analysis of block of variables (first eigenvalue of the correlation matrix of manifest variables must be larger than 1 and the second one smaller than 1, or at least very far from the one) and composite reliability (should be >0.7).

Moreover, average variance extracted (AVE) is calculated to estimate discriminant validity, that is the percentage of variance that is captured by the construct in relation to the variance due to random measurement error (should be >0.5). Likewise, cross loadings are calculated when two or more reflective constructs are in the model. It can be obtained by calculating the correlations between latent variables component scores and indicators associated with other reflective constructs. In regards to formative blocks, weights (w) allowing determining the extent to which each indicator contributed to the formation of the constructs. Unlike reflective blocks, both unidimensionality and high co-linearity are not a necessary condition.

The relation between latent variables is assessed examining the path coefficients (standardized beta, >) between latent variables. To assess the significance of loadings, weights and path coefficients, standard error and t-values are calculated by bootstrapping resampling technique (>1.65 significant at 0.05 level; >2 significant at 0.01 level) and by Rubin's rules in the multiple imputations cases. R-square of each endogenous variable gives the overall fit of the model or the percentage of variance explained by the model.

Generally, the data samples have important percentages of missing values. To solve this problem, multiple imputation techniques, as predictive mean matching, are used to not exclude cases and to take into account the uncertainty of imputed value.

The estimation of the patent value as second-order latent variables is made using hierarchical component model, where manifest variables of first-order latent variables are repeated for the second-order latent variable ( ).

The disclosed method allows obtaining the value of patent using two types of data matrices: a matrix ordered by patents and a matrix ordered by company in one or several periods.

The method allows knowing and distinguishing between the index value of patent portfolio given by specific characteristics of technology itself (a priori technological index value) and an index value given by the market.

The a priori technological index value is estimated considering at least the knowledge stock, technological scope and international scope of the invention.

The index value given by the market is estimated through at least by technological usefulness, being possible to use in addition the market value of companies.

Whether a matrix ordered by patents is used, the index value of the patent portfolio is obtained by adding the estimated value of each patent.

Whether the matrix ordered by applicant or owner is used, the index value of the patent portfolio is obtained for each company of the estimation of the model.

Patent value index, prior value of technology index and posteriori value of technology index, knowledge stock value index, technological scope, international scope and technological usefulness indexes are obtained directly for each patent portfolio, which allows performing a comparison between two companies or technological areas, among other.

The invention includes a computer system that implements the method described. This consists of a data input device, a device for data processing and a data output device.

Also part of the invention is a database with economical data obtained from the applicants owning the patent documents considered to feed the market value variable.

An expert in the art would recognize that other latent variables could be added to the described models and method implementing the invention keeping the general structure here disclosed.

1. A computer implemented multidimensional method for patent and technology portfolio rating comprising:
selecting a large group of patent documents from a database or other source;
extracting a predetermined number of manifest variables or indicators from each of the patent documents;
defining for each patent document from a selected number of said manifest variables at least the following four underlying first order latent variables:
knowledge stock,
technological scope,
international scope, and
patent value and further defining a dependency or causality relationship between said manifest and latent variables and between latent variables;
constructing a PLS Path model operable on said manifest variables taking into account said latent variables and defined relationships among them and obtaining the value of said latent variables and the dependency relationship between manifest and latent variables and between latent variables; and
using said obtained values of the latent variables to construct a rank of the selected patent documents.

2. A method, according to claim 1, wherein said extracting comprises collecting indicators from the patent documents.

3. A method, according to claim 1, wherein said large group comprises at least 100 patent documents.

4. A method, according to claim 1, further comprising obtaining the significance level of the obtained relationship values of said latent/manifest variables by resampling techniques.

5. A method, according to claim 1, wherein knowledge stock is evaluated from at least the following patent indicators: backwards citations and the number of inventors and wherein other indicators as the number of applicants can also be used.

6. A method, according to claim 1, wherein technological scope is evaluated from at least the number of claims and the number of technological areas where the patent is protected.

7. A method, according to claim 1, wherein international scope is estimated from dummy variables, to consider whether the invention has been protected in the major market related with the technical fields of the invention during the priority period or international phase period.

8. A method, according to claim 1, wherein patent value is evaluated using as indicator at least the number of occasions that patent is cited.

9. A method, according to claim 1, wherein for each patent document is defined a further first order latent variable comprising the market value of an applicant or owner of said patent document, defining its manifest variables from economical indicators as total asset and R&D expenditures of the applicant or owner and also defining the dependency relationship between said manifest and latent variable and between said market value variable and previous latent variables.

10. A method, according to claim 1, wherein for each patent document is defined a further first order latent variable consisting on the technological usefulness of an applicant or owner of said patent document, defining its manifest variables from patent indicators as at least forward citations (reflective relation), also defining the dependency relationship between said manifest and latent variable and between said technological usefulness variable and previous latent variables, patent value being then a second order latent variable.

11. A method, according to claim 8, wherein said indicators used to evaluate said first order latent variable further include the number of oppositions and/or the number of times that a patent is renewed and/or the number of countries where the patent is protected or the size of patent family.

12. A method according to claim 10, wherein for each patent document is defined a further first order latent variable consisting on the market value of an applicant or owner of said patent document, defining its manifest variables from economical indicators as total asset and R&D expenditures of the applicant or owner and also defining the dependency relationship between said manifest and latent variable and between said market value variable and previous latent variables.

13. A method according to claim 9, wherein a multiple imputation technique is used to solve the problem of missing values in economical data for said economical indicators.

14. A method according to claim 10, wherein a hierarchical component model is used to solve the problem of second order latent variable repeating manifest variables of first-order latent variables for the second-order latent variable.

15. A method according to claim 1, wherein a set of indexes is obtained either by patent or by applicant or owner, including an index of value estimated from explicit estimation of latent variables that PLS makes from the manifest variables and other indexes of value estimated from an explicit estimation of the latent variables that PLS makes from the outer estimation, and wherein said set of indexes comprises at least:
a patent index value of the patent portfolio obtained by adding the estimated value of each patent or obtained for each applicant or owner;
knowledge stock index value;
technological scope index value obtained by the addition of technological scope units of the inventions and estimated by applicant among others;
international scope index value obtained by the addition of International scope units of the inventions and estimated by applicant among others;
technological usefulness index value, obtained by the addition of the technological usefulness units of the inventions and estimated by applicant among others,
said indexes allowing a comparison between two companies or technological areas among others.

16. A method according to claim 1, wherein a set of indexes is obtained either by patent or by applicant or owner, including an index of value estimated from explicit estimation of latent variables that PLS makes from the manifest variables and other indexes of value estimated from an explicit estimation of the latent variables that PLS makes from the outer estimation, and wherein said set of indexes comprises:
a priori index value of technology estimated considering at least the knowledge stock, technological scope and international scope of the invention; and
a posteriori index value of technology estimated considering at least the technological usefulness and wherein the market value of applicant or owner can be also used.

17. A method according to claim 1, wherein a matrix ordered by patents or a matrix ordered by applicant or owner is used to construct said rank.

18. A computer system that implements the method described in claim 1, comprising a data input device, a device for data processing and a data output device.

19. A database for use with the method of claim 9, wherein economical data obtained from the applicants or companies owning the patent documents is used to feed the market value variable.

20. A method, according to claim 10, wherein said indicators used to evaluate said first order latent variable further include the number of oppositions and/or the number of times that a patent is renewed and/or the number of countries where the patent is protected or the size of patent family.

21. A method according to claim 12, wherein a multiple imputation technique is used to solve the problem of missing values in economical data for said economical indicators.

22. A method according to claim 12, wherein a hierarchical component model is used to solve the problem of second order latent variable repeating manifest variables of first-order latent variables for the second-order latent variable.

23. A method according to claim 9, wherein a set of indexes is obtained either by patent or by applicant or owner, including an index of value estimated from explicit estimation of latent variables that PLS makes from the manifest variables and other indexes of value estimated from an explicit estimation of the latent variables that PLS makes from the outer estimation, and wherein said set of indexes comprises at least:
a patent index value of the patent portfolio obtained by adding the estimated value of each patent or obtained for each applicant or owner;
knowledge stock index value;
technological scope index value obtained by the addition of technological scope units of the inventions and estimated by applicant among others;
international scope index value obtained by the addition of International scope units of the inventions and estimated by applicant among others;
technological usefulness index value, obtained by the addition of the technological usefulness units of the inventions and estimated by applicant among others,
said indexes allowing a comparison between two companies or technological areas among others.

24. A method according to claim 10, wherein a set of indexes is obtained either by patent or by applicant or owner, including an index of value estimated from explicit estimation of latent variables that PLS makes from the manifest variables and other indexes of value estimated from an explicit estimation of the latent variables that PLS makes from the outer estimation, and wherein said set of indexes comprises at least:
a patent index value of the patent portfolio obtained by adding the estimated value of each patent or obtained for each applicant or owner;
knowledge stock index value;
technological scope index value obtained by the addition of technological scope units of the inventions and estimated by applicant among others;
international scope index value obtained by the addition of International scope units of the inventions and estimated by applicant among others;
technological usefulness index value, obtained by the addition of the technological usefulness units of the inventions and estimated by applicant among others,
said indexes allowing a comparison between two companies or technological areas among others.

25. A method according to claim 12, wherein a set of indexes is obtained either by patent or by applicant or owner, including an index of value estimated from explicit estimation of latent variables that PLS makes from the manifest variables and other indexes of value estimated from an explicit estimation of the latent variables that PLS makes from the outer estimation, and wherein said set of indexes comprises at least:
a patent index value of the patent portfolio obtained by adding the estimated value of each patent or obtained for each applicant or owner;
knowledge stock index value;
technological scope index value obtained by the addition of technological scope units of the inventions and estimated by applicant among others;
international scope index value obtained by the addition of International scope units of the inventions and estimated by applicant among others;
technological usefulness index value, obtained by the addition of the technological usefulness units of the inventions and estimated by applicant among others,
said indexes allowing a comparison between two companies or technological areas among others.

26. A method according to claim 9, wherein a set of indexes is obtained either by patent or by applicant or owner, including an index of value estimated from explicit estimation of latent variables that PLS makes from the manifest variables and other indexes of value estimated from an explicit estimation of the latent variables that PLS makes from the outer estimation, and wherein said set of indexes comprises:
a priori index value of technology estimated considering at least the knowledge stock, technological scope and international scope of the invention; and
a posteriori index value of technology estimated considering at least the technological usefulness and wherein the market value of applicant or owner can be also used.

27. A method according to claim 10, wherein a set of indexes is obtained either by patent or by applicant or owner, including an index of value estimated from explicit estimation of latent variables that PLS makes from the manifest variables and other indexes of value estimated from an explicit estimation of the latent variables that PLS makes from the outer estimation, and wherein said set of indexes comprises:
a priori index value of technology estimated considering at least the knowledge stock, technological scope and international scope of the invention; and
a posteriori index value of technology estimated considering at least the technological usefulness and wherein the market value of applicant or owner can be also used.

28. A method according to claim 12, wherein a set of indexes is obtained either by patent or by applicant or owner, including an index of value estimated from explicit estimation of latent variables that PLS makes from the manifest variables and other indexes of value estimated from an explicit estimation of the latent variables that PLS makes from the outer estimation, and wherein said set of indexes comprises:
a priori index value of technology estimated considering at least the knowledge stock, technological scope and international scope of the invention; and
a posteriori index value of technology estimated considering at least the technological usefulness and wherein the market value of applicant or owner can be also used.

29. A method according to claim 9, wherein a matrix ordered by patents or a matrix ordered by applicant or owner is used to construct said rank.

30. A method according to claim 10, wherein a matrix ordered by patents or a matrix ordered by applicant or owner is used to construct said rank.

31. A method according to claim 12, wherein a matrix ordered by patents or a matrix ordered by applicant or owner is used to construct said rank.

32. A computer system that implements the method described in claim 9, comprising a data input device, a device for data processing and a data output device.

33. A computer system that implements the method described in claim 10, comprising a data input device, a device for data processing and a data output device.

34. A computer system that implements the method described in claim 12, comprising a data input device, a device for data processing and a data output device.

35. A computer system that implements the method described in claim 16, comprising a data input device, a device for data processing and a data output device.

36. A computer system that implements the method described in claim 17, comprising a data input device, a device for data processing and a data output device.
